(19) United States
(12) Patent Application Publication
(10) Pub. No.: US 2002/0157706 A1
(43) Pub. Date: Oct. 31, 2002

(54) Two-stage float operated fuel tank vent valve

(75) Inventor: Rudolph Bergsma, Ann Arbor, MI (US)

Correspondence Address: EATON CORPORATION, EATON CENTER, 1111 SUPERIOR AVENUE, CLEVELAND, OH, 44114

(73) Assignee: EATON CORPORATION, Cleveland, OH

(21) Appl. No.: 09/841,934

(22) Filed: Apr. 25, 2001

(51) Int. Cl. F16K 24/04

(52) U.S. Cl. 137/202; 251/901

(57) ABSTRACT

A float operated fuel tank vent valve has a pair of vent passages with one of the pair larger than the other. A thin flexible elastomeric strip valve has one end attached to the valve body and the distal end bent over the top of the float and attached thereto. The strip valve has a pair of annular sealing surfaces formed thereon each disposed respectively opposite one of the vent passages. Upon refueling of the tank, as the float rises, the strip valve first progressively closes the larger vent passage and then progressively closes the smaller vent passage. As fuel is drawn from the tank by engine operation and the float is lowered, the strip valve is first peeled away from one edge of the smaller vent passage and then completely opens the smaller vent passage. As the float is further lowered, the valve strip is peeled away from one edge of the longer vent passage and then completely open the larger vent passage.

### BACKGROUND OF THE INVENTION

The present invention relates to vapor vent valves for vehicle fuel tanks and particularly valves of the float operated type which provide venting of the fuel vapor above the surface of the liquid typically to a storage canister for later purge and flow to the engine air inlet upon engine startup. Float operated valves of this type are known to provide a two-stage venting wherein upon refueling, fuel vapor is initially vented through a relatively large opening; and, upon the fuel level nearing the top of the fuel tank the valve is operative to reduce the area for the vent flow.

In one known technique for providing two-stage fuel vapor venting during refueling of a fuel tank, the main valve member has a pilot passage through the valve member which pilot passage remains open upon closing of the main valve member and the pilot passage is subsequently closed as the fuel level reaches the top of the fuel tank.

Another known technique employed for providing two-stage venting of vapor from a fuel tank with a float operated valve, is that of providing separate ports for venting with the ports closed sequentially by individual valving surfaces mounted on the float. It is also known to provide a peel-away type flexible membrane or strip valve member for a vent port in a float operated fuel vapor vent valve in order to prevent “corking” of the valve in the closed position from the buoyancy forces acting on the float which can subsequently prevent reopening of the valve when the fuel level drops.

Problems with sticking or “corking” of float operated fuel vapor vent valves for vehicle fuel tanks have been persistent and have brought about a need to provide two stage venting of fuel vapor from a vehicle fuel tank utilizing a float operated valve and eliminate “corking” or sticking of the valve upon lowering of the fuel level in the tank for reopening the valve.

In float operated fuel tank vapor vent valves having two-stage venting with plural vent ports progressively closed by separate valve members upon rising fuel level in the tank, sticking of the valves upon lowering of the fuel level slowly as occurs during engine operation, has also resulted in misalignment or “cocking” of the float due to the asymmetric forces on the float applied by the gravitational weight of the float and the reaction force of the stuck or closed valve member on one of the vent ports. This misalignment of the float has under certain conditions resulted in sticking of the float and malfunction of the valve.

It has thus long been desired to provide a way or means of progressively closing plural vent ports in a float operated fuel vapor vent valve to provide two-stage venting and to provide such a valve which is not prone to float sticking or to either of the vent port valve members being stuck in the closed position so as to prevent re-opening upon decreasing of the fuel level in the tank during engine operation and to provide such a valve which is relatively low in manufacturing cost and is easy to assemble and install in the fuel tank.

### BRIEF SUMMARY OF THE INVENTION

The present invention provides the float operated fuel vapor vent valve for use in vehicle fuel tanks of the type which is float operated. The valve of the present invention progressively closes a first and second vent port as the float rises and progressively opens the ports in reverse sequence as the float is lowered from fuel withdrawal from the tank during engine operation.

The float has an end portion of a flexible membrane or strip attached thereto with the distal end of the membrane secured to the valve body such that progressive or sequential peeling of the membrane from the ports occurs as the float is lowered during fuel withdrawal from the tank. The peel-away action of the membrane requires only a relatively small force to initially crack open the membrane from one edge of a vent port; and, thus the valve is not stuck in the port closed position because of insufficient net downward force on the float to pull the membrane away from the port. As the float continues to be lowered by fuel withdrawal from the tank, the membrane progressively uncovers a second port to increase the venting flow area of the valve. In the presently preferred practice, upon rising fuel level in the tank during refueling, the membrane is operative to progressively first close a larger vent port and upon the fuel level nearing the top of the tank the second or smaller port is closed. Upon withdrawal fuel from the tank and lowering of the float the small port is first progressively opened by the peel-away action and sequentially thereafter the larger port is opened by a peel-away action of the membrane.

### BRIEF DESCRIPTION OF THE DRAWINGS

FIG. 1 is a cross-sectional view of the vent valve assembly of the present invention showing the float operated membrane valve in the position closing both vent ports;

FIG. 2 is an enlarged view of the port of FIG. 1 showing the float lowered to a positional position initially cracking open the smaller vent port;

FIG. 3 is a view similar to FIG. 2 showing the smaller vent port completely opened and the membrane initially opening the larger vent port; and,

FIG. 4 is a view similar to FIG. 1 showing the valve with the float in the lowered position fully opening both vent ports.

### DETAILED DESCRIPTION OF THE INVENTION

Referring to FIG. 1, the valve assembly of the present invention is indicated generally at 10 as installed in an inwardly flanged access opening 12 provided in the upper wall 14 of a vehicle fuel tank. The valve has an exterior vent portion 16 having a connector 18 thereon for connection through a conduit 20 to a storage canister 22. The external portion of the valve 16 has provided therein a first vent port 24 and a second smaller vent port 26 spaced therefrom in side-by-side relationship both of which communicate the interior of the tank and with conduit 20 through passage 28 formed in the connector 18.

The exterior portion 16 of the valve is attached to a valve body 30 which extends downwardly through the opening 12 into the fuel tank; and, body 30 is sealed on the upper portion by suitable seal ring 32 and retained thereon by any suitable expedience such as welding or fasteners 34. The body 30 is sealed in the access opening 12 by a seal ring 36 to prevent escape of fuel vapor between the valve body and the upper wall of the fuel tank.

A float 38 is disposed within chamber 40 formed within the body 30 and float 38 is slidably guided for vertical movement therein by a wall or partition 42. The float is biased in an upward direction by a spring 44 which has a spring rate chosen and is calibrated such as to provide the desired force on the float to provide the desired buoyancy in the particular fuel to be used in the tank.

The upper end of the float 38 has a notch or shoulder 46 formed therein. One end of a flexible membrane 48 is secured on shoulder 46 by any suitable expedient as, for example, by a fastener 50, with the membrane 48 bowed around the upper edge of the float and disposed along the top surface thereof with the opposite or distal end of the membrane secured to the valve body 30 by a suitable fastening technique such as a deformable pull-through barbed tab denoted by reference numeral 52. The membrane preferably is formed of elastomeric material and has a strip-like configuration with an annular lip formed integrally thereon and extending upwardly therefrom along the upper surface of the float and disposed to close over the smaller vent port 26 as denoted by reference numeral 54. Similarly, a second raised annular lip 56 is provided on membrane 48 in spaced relationship to the annular lip 54; and, the lip 56 is disposed to close over the lower end of the larger vent port 24. The float is shown in the upward limit of its travel in FIG. 1 with the annular lip 54 in a position closing port 26 and the annular lip 56 in a position closing port 24.

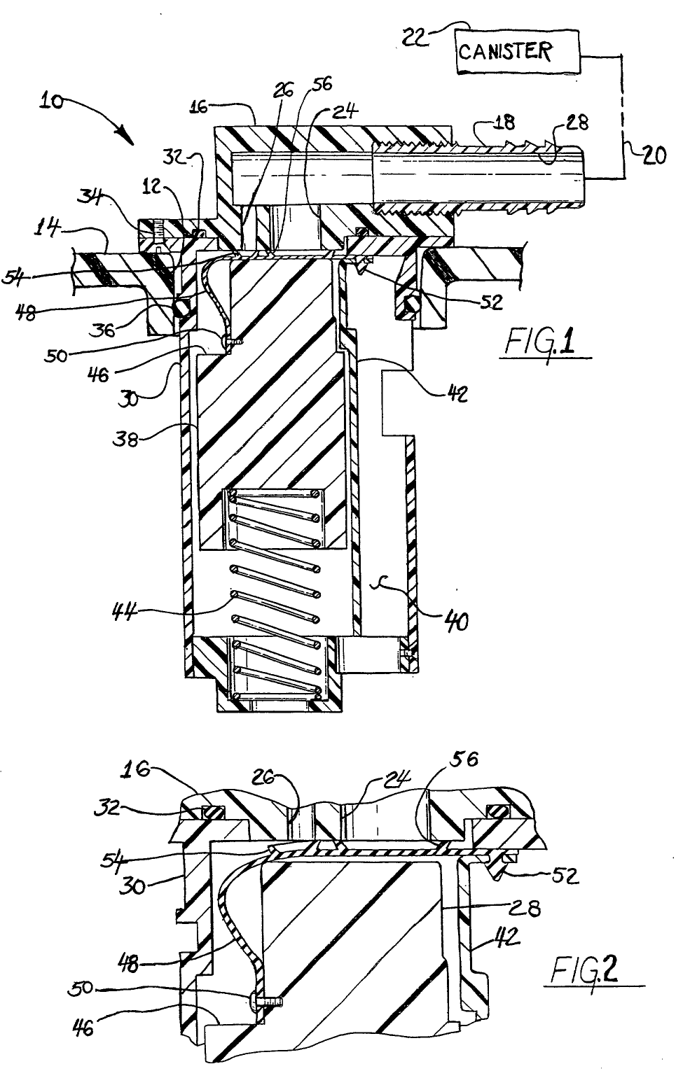

Referring to FIG. 2, float 28 is shown in a position lowered slightly from the position of FIG. 1 wherein one side of annular lip 54 has begun to peel away from one side of the smaller vent port 26 permitting some venting therethrough. With the float in the position shown in FIG. 2 annular seal lip 56 is maintained completely in the closed condition covering the larger vent port 24.

Referring to FIG. 3, the float 38 is illustrated as lowered further from the position shown in FIG. 2 to a position in which the membrane 48 has been moved downwardly to cause the annular lip 54 to completely uncover the smaller vent port 26. In the float position shown in FIG. 3, the membrane 48 has moved one side of the annular lip 56 downwardly to peel away from one side of the larger vent port 24 to permit initial vapor flow from the tank interior through the port 24.

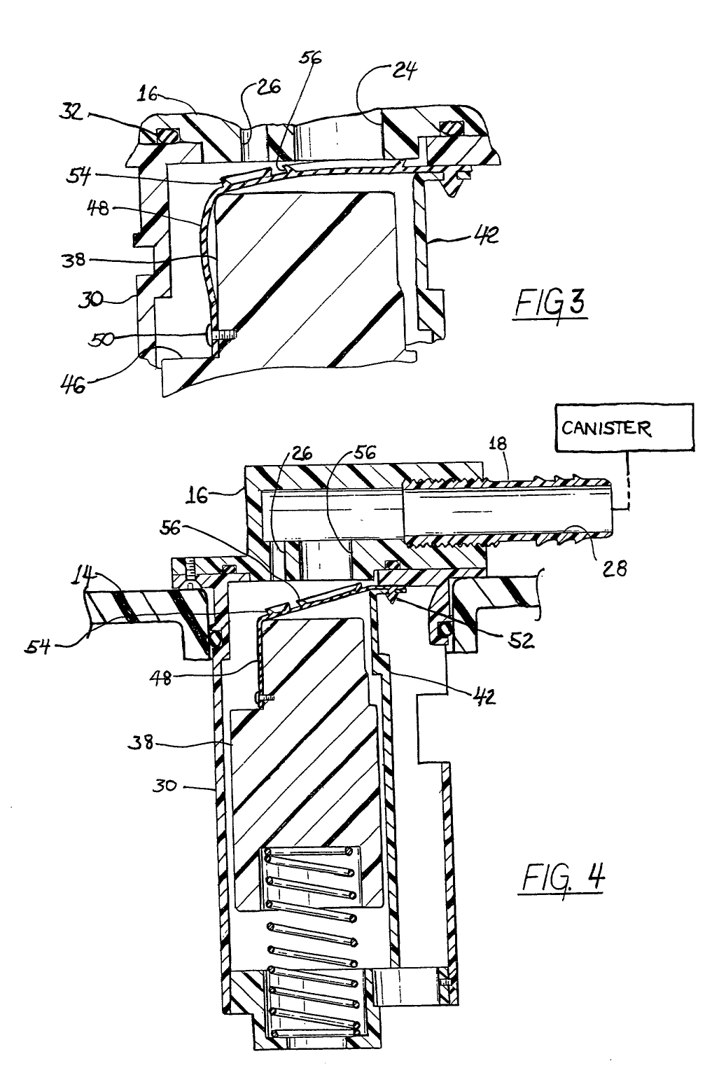

Referring to FIG. 4, the float 38 is shown in a position lower than the position of FIG. 3 as caused by withdrawal of additional fuel from the tank. In the float position of FIG. 4, the membrane 48 has been pulled downwardly to a position causing annular lip 56 to be completely pulled away from the port 24 and opening port 24 as well as port 26 for full vent flow therethrough.

The present invention thus provides a unique and novel two-stage float operated fuel vapor vent valve for installation in a vehicle fuel tank. A relatively thin flexible membrane strip of preferably elastomeric material has one end attached to the float with the distal end anchored to the valve body in a curved or bent configuration. The membrane has a pair of annular seal lips or ribs formed thereon which are disposed in spaced side-by-side relationship with each disposed to align with a corresponding vent port provided in the cover or top portion of the valve. With the fuel tank completely filled, the buoyant forces on the float cause the float to rise to a position closing the annular seal ribs on the membrane over their respective vent ports to prevent fuel vapor from escaping the tank. As fuel is withdrawn from the tank and the float is slowly lowered, the membrane initially opens one side of one of the annular ribs in a peel-away action from one of the ports. As the float drops further, the peel-away action causes the annular rib to completely open the first vent port. As the float descends further due to fuel withdrawal from the tank, one side of the second annular rib is opened from one side of the second vent port in a peel-away action to permit some vapor to begin passing through the second port. As the float descends even further due to fuel withdrawal from the tank, the membrane is caused to pull the second annular rib completely away from the second vent port permitting full flow through both vent ports.

The flexible membrane valve member of the present invention provides a unique peel-away action for progressively opening sequentially each of the two vent ports and thus enables the valve to positively open in a manner which requires a very low force to open the vent ports and thus prevents corking or sticking of the valve in the closed position when the tank is filled with fuel.

Although the invention has hereinabove been described with respect to the illustrated embodiments, it will be understood that the invention is capable of modification and variation and is limited only by the following claims.

1. A float operated vapor vent valve assembly for a fuel tank comprising:
(a) a housing adapted for mounting through an access opening in the top of the fuel tank, said housing having a first and a second vent opening therethrough in side-by-side spaced arrangement for communicating fuel vapor with the exterior of the tank, with said float disposed in said housing; and,
(b) a flexible valve member having one end anchored to said housing and an end distal said one end anchored to said float, wherein said float is operative at a first fuel level to close said valve member against said first and second vent opening, said float is operative upon descending to a second fuel level slightly lower than said first level to begin progressively peeling said valve member away from one side to the other of said second opening, and said float is operative upon further descending to a third level to peel away said valve member completely from said second opening and to begin progressively peeling away said valve member from one side to the other of said first opening and said float is operative upon further descending to a fourth level to completely open said first opening.

2. The valve assembly defined in claim 1, wherein said valve member comprises a relatively thin strip of elastomeric material.

3. The valve assembly defined in claim 1, wherein said valve member comprises a relatively thin membrane having a first and second annular sealing lip formed thereon for sealing respectively against said first and second vent openings.

4. The valve assembly defined in claim 1, wherein said valve member comprises a relatively thin strip of elastomer bowed to about a right angle.

5. The valve assembly defined in claim 1, wherein the top of said float is operative at said first level to contact said valve member in the region between said anchored ends and urges said valve member against said second and first vent opening.

6. The valve assembly defined in claim 1, wherein said housing includes a first portion guiding said float and extending through said tank access opening and second portion attached to said first portion with said second and first vent openings formed therein, said second portion extending exteriorly of said access opening.

7. The valve assembly defined in claim 1, wherein the said openings is larger than the other.

8. A method of controlling venting fuel vapor in a tank comprising:
(a) disposing a valve housing through an access opening in the top of the fuel tank and forming a first and a second vent opening in said housing communicating to the tank exterior;
(b) disposing a float in said tank and guiding movement of said float with said housing;
(c) disposing a flexible valve member in said housing adjacent said first and second vent openings and anchoring one end of said valve member to said float and an end distal said one end to said housing; and, closing said first and second vent port with said valve member when said tank is full; and,
(d) progressively peeling away said valve member first from said second vent and subsequently from said first vent as said float descends in said tank upon fuel usage therefrom.

9. The method defined in claim 8, wherein said step of disposing a valve member includes forming a large and smaller annular resilient sealing lip on said member.

10. The method defined in claim 8, wherein said step of disposing a valve member includes forming a relatively thin strip of material and anchoring one end to the float and an end distal the one end to the housing.

11. The method defined in claim 8, wherein said step of disposing a valve member includes forming a relatively thin strip of elastomeric material and anchoring one end to the float and an end distal the one end to the housing.

12. The method defined in claim 8, wherein said step of disposing a valve member includes bowing a relatively thin strip of material and anchoring one end to the housing and an end distal the one end to the float.

13. The method defined in claim 8, wherein said step of disposing a valve member includes bowing a relatively thin strip of material at about a right angle and anchoring one end to the float and an end distal the one end to the housing.

14. The method defined in claim 8, wherein the step of forming a first and second vent opening includes forming one of the openings larger than the other.
